(19) United States
(12) Patent Application Publication
(10) Pub. No.: US 2005/0073512 A1
(43) Pub. Date: Apr. 7, 2005

(54) DISPLAY HAVING A PLURALITY OF DISPLAY REGIONS

(76) Inventor: Hong-Da LIU, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,374

(22) Filed: Feb. 26, 2004

(30) Foreign Application Priority Data
Oct. 1, 2003 (TW) 092127236

(51) Int. Cl. G09G 3/36; G09G 5/00

(52) U.S. Cl. 345/204

(57) ABSTRACT

A display having a plurality of display regions includes at least a first display region and a second display region being of different display modes, a first pixel array and a second pixel array, and a first driving array and a second driving array. The driving arrays are used to control the image display of the display regions of the display.

### BACKGROUND OF INVENTION

1. Field of the Invention

The present invention relates to a display, and more specifically, to a display having a plurality of display regions and driving circuit arrangement.

2. Description of the Prior Art

Mobile phones have been a popular product throughout recent years, and accordingly, the mobile phone display has become a key component. In order to satisfy requirements from users and keep pace with the increasing development, a display having two sides both being capable of displaying images is needed.

A conventional two-side display adheres two displays together. This kind of adhesion not only causes wasted materials, since two displays are used, but twice the power supply capacity is also needed. Thus power consumption of the mobile phone is extremely large and the battery needs to be replaced or recharged frequently. Moreover, this kind of adhesion is of course thick and heavy, which are fatal disadvantages to a portable electronic device.

### SUMMARY OF INVENTION

It is therefore a primary objective of the present invention to provide a display having two sides capable of displaying images, in order to solve the aforementioned problems.

Briefly summarized, a display having a plurality of display regions includes at least a first display region and a second display region being in different display modes, a first pixel array and a second pixel array, and a first driving array and a second driving array. The driving arrays are used to control the image display of each display region of the display. The image display of first display region and the image display of second display region can be displayed in the same or different sides.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a display panel according to the present invention.

FIG. 2 is a cross-section view along line A-A in FIG. 1.

FIG. 3 illustrates a subpixel surrounded by another subpixel in a pixel.

FIG. 4 illustrates two aligned subpixels in a pixel.

FIG. 5 illustrates a transmissive substrate.

FIG. 6 illustrates a reflective substrate.

FIG. 7 illustrates a transflective substrate.

FIG. 8 illustrates the substrate divided into a plurality of regions in different structures.

FIG. 9 illustrates TFT arrays of a LCD.

FIG. 10 illustrates the first side of the display controlled by two TFT arrays, and the second side of the display controlled by one of the TFT array.

FIG. 11 illustrates the first side of the display controlled by the TFT array.

FIG. 12 illustrates the utilization of a single data controller.

FIG. 13 illustrates the panel divided into regions.

FIG. 14 is a diagram of a one-side or two-side display according to the present invention.

FIG. 15 is a side view of the display.

FIG. 16 is another side view of the display.

FIG. 17 is another side view of the display.

FIG. 18 illustrates the first side and the second side of the display according to the present invention.

FIG. 19 illustrates the first side and the second side displaying the same image.

FIG. 20 illustrates the first side and the second side displaying inverse images.

FIG. 21 illustrates a circuit diagram of a two-side display according to the present invention.

FIG. 22 illustrates a display using two data controllers according to the present invention.

FIG. 23 illustrates the panel divided into two regions.

FIG. 24 is a circuit diagram of the display using two data controllers.

FIG. 25 is another circuit diagram of the display using two data controllers.

FIG. 26 illustrates a two-side display of the display using two data controllers according to the present invention.

FIG. 27 shows possible combinations of two subpixels of a pixel in the region on the substrate.

### DETAILED DESCRIPTION

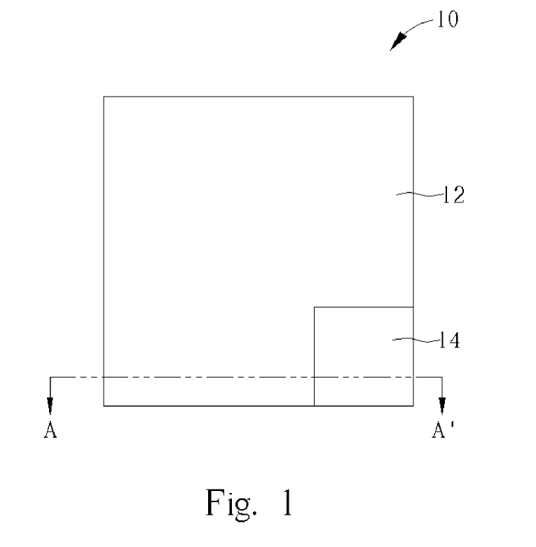

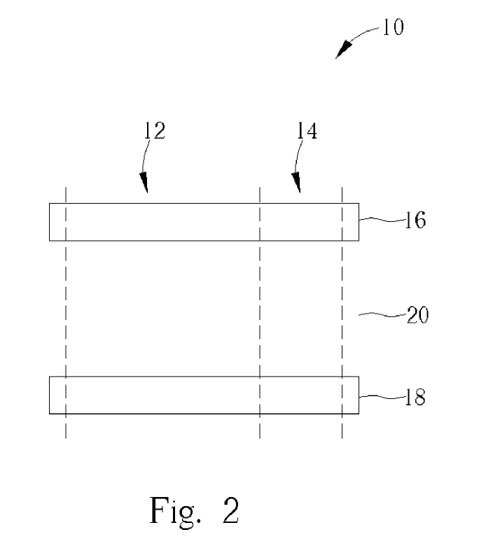

Please refer to FIG. 1 and FIG. 2 showing the structure of a panel 10 of a display according to the present invention. FIG. 1 is a diagram of the panel 10. The panel 10 can be divided into at least two regions, such as regions 12 and 14. These regions 12, 14 can be in different shapes, sizes or colors. FIG. 2 is a cross-section view along line A-A in FIG. 1. The panel 10 includes two substrates 16, 18, and a liquid crystal layer 20 between the substrates 16, 18. The region 12 and the region 14 include a plurality of pixels and the substrate 18 includes a plurality of first and second driving arrays to determine the status of the liquid crystal layer 20 in the region 12 and the region 14, respectively. If the display is a liquid crystal display (LCD), the first and the second driving arrays are thin film transistor (TFT) arrays. The present invention divides every pixel in the region 12 and the region 14 into at least one subpixel being of different shapes, size or regions, configures the structure of the substrate 18 in units of subpixels to be transmissive, reflective or transflective, and utilizes the first and the second driving arrays to control the liquid crystal layer 20 in order to display images on a first side, a second side, or on both sides of the display. The panel 10 can be twisted nematic (TN), super twisted nematic (STN), TFT, thin film diode (TFD), low temperature polysilicon (LTPS) thin film transistor, or electrophoretic display (EPD). The mode of the LCD can be RSTN, RTN, RECB, MTN or VA mode.

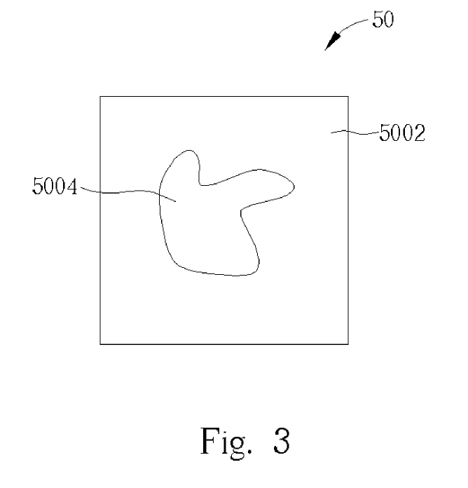

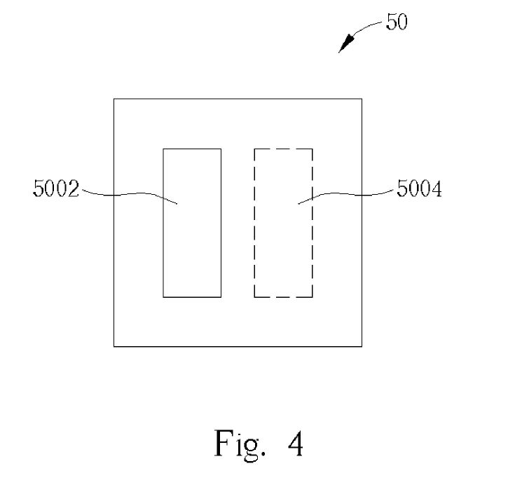

Please refer to FIG. 3 and FIG. 4 showing a pixel 50 having two subpixels 5002, 5004. Each pixel in the region 12 and the region 14 can be divided into pixels having different shapes, size, and colors. As shown in FIG. 3, in a pixel 50, the subpixel 5004 is surrounded by the subpixel 5002. As shown in FIG. 4, the subpixels 5002, 5004 may also be aligned.

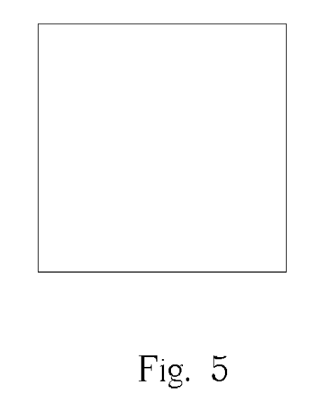

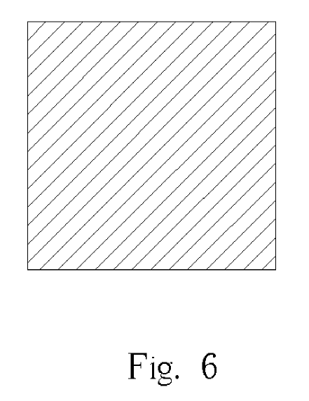

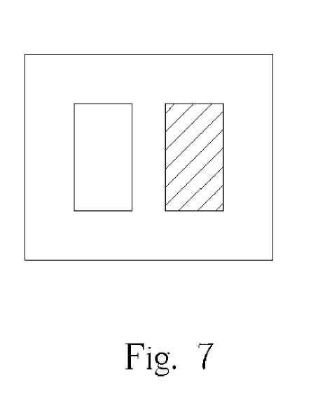

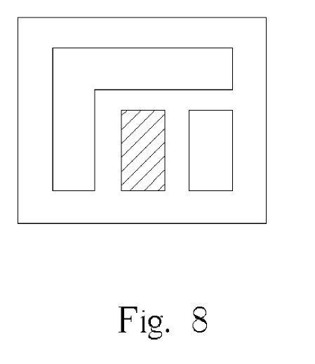

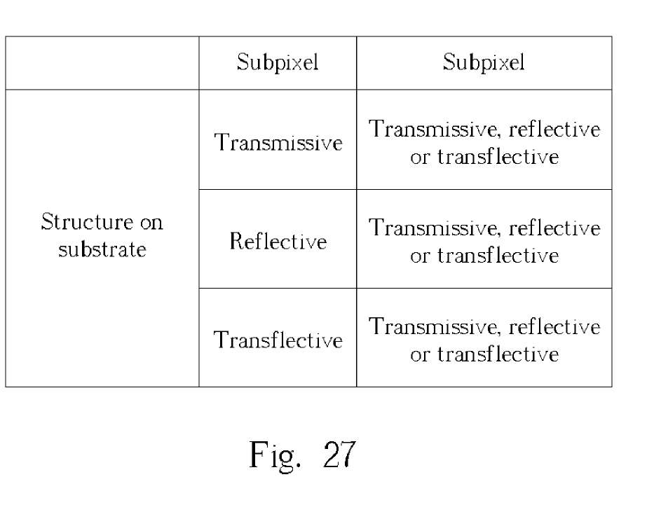

Please refer to FIG. 5 to FIG. 7 showing the structure of the substrate 18. FIG. 5 shows a transmissive substrate 18, FIG. 6 shows a reflective substrate 18, and FIG. 7 shows a transflective substrate 18. FIG. 27 shows possible combinations of two subpixels 6002, 6004 of a pixel in the region 12 or the region 14 on the substrate 18. In the same pixel, if the subpixel 6002 is transmissive, the subpixel 6004 can be transmissive, reflective or transflective. The present invention divides the panel into at least two regions, and divides each pixel in each region into at least one subpixel of different structures, such as transmissive, reflective or transflective. FIG. 8 shows the substrate 18 divided into a plurality of regions of different structures. Additionally, the subpixels of each pixel can also be of different structures.

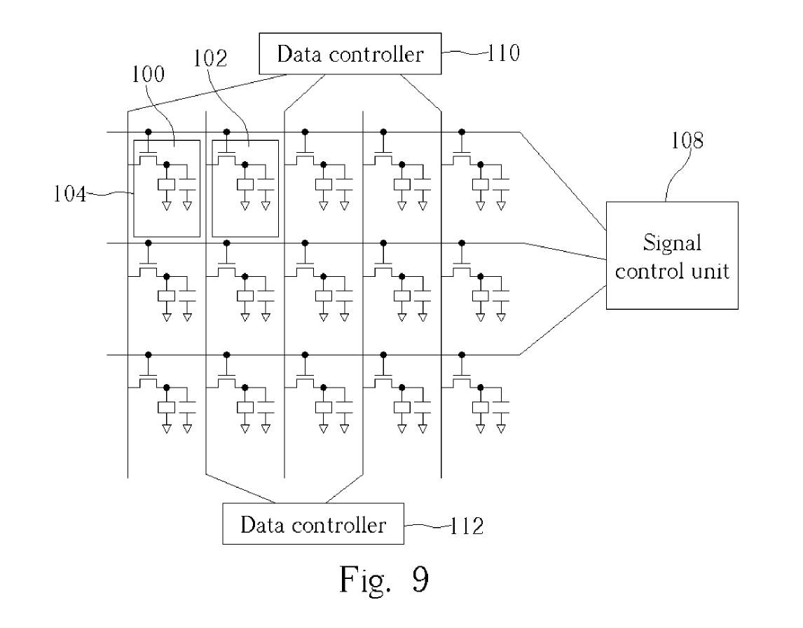

Please refer to FIG. 9 showing a TFT array of the LCD. A TFT controls a liquid crystal molecule corresponding to a subpixel to twist. For instance, TFTs 100, 102 control liquid crystal molecules corresponding to subpixels 104, 106, respectively. A signal control unit 108 connects gates of the TFTs in order to switch on and off the TFTs. The present invention provides a two-side display, dividing a pixel into at least one subpixel, and dividing each TFT in a region into at least one set of TFT arrays. Two sets of TFT arrays are shown in FIG. 9, which control different liquid crystal molecules corresponding to subpixels to twist, in order to display images on the first side and the second side of the LCD. Data controllers 110, 112 obtain video data from a memory storing video data, in order to display images on the first side and the second side of the LCD. When the data controllers 110, 112 are respectively connected to two sets of TFT arrays, the first side and the second side of the LCD can display different images. The present invention can also use a single data controller connected to two sets of TFT arrays, in this case the first side and the second side of the LCD display the same image.

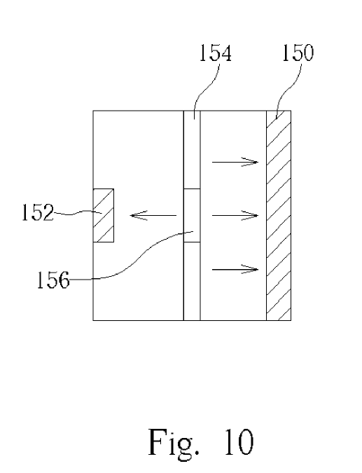

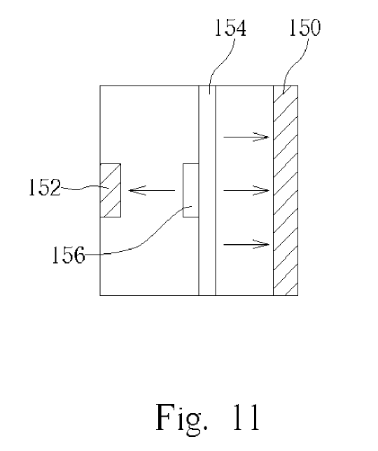

Please refer to FIG. 10 showing the first side 150 of the display controlled by two TFT arrays 154, 156, and the second side of the display controlled by the TFT array 156. When displaying images, the second side 152 corresponds to a part of the TFT array 156 of the first side 150 and displays the same image. As shown in FIG. 11, the first side 150 of the display is controlled by the TFT array 154. When displaying images, if the TFT arrays 154, 156 are connected to different data controllers, the first side 150 and the second side 156 display different images. If the TFT arrays 154, 156 are connected to the same data controller, the image displayed by the first side 150 and the second side 152 can be determined according to a sequence of connection of the TFT arrays 154, 156.

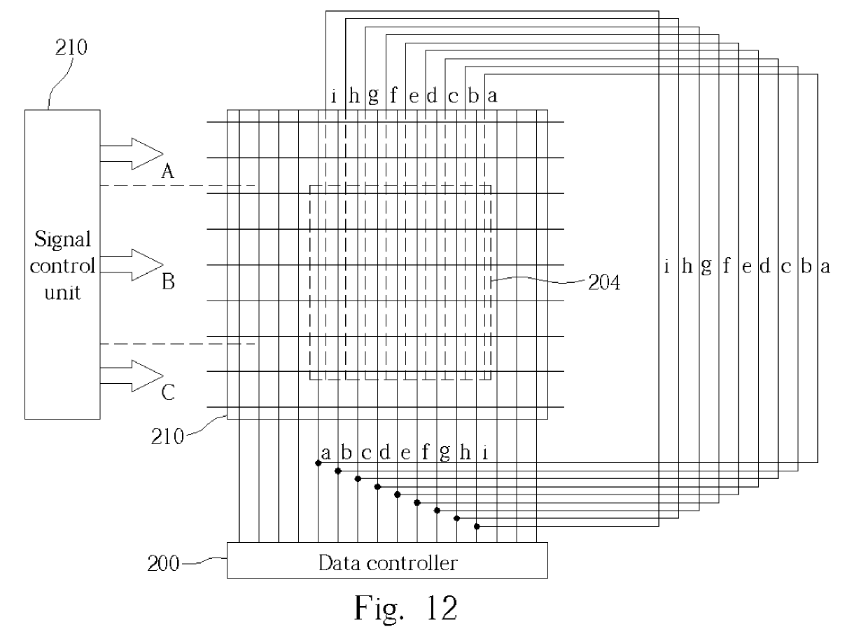

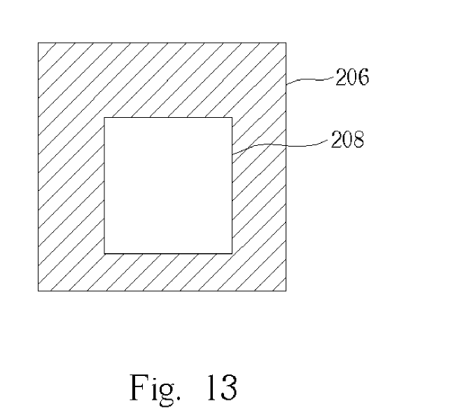

Please refer to FIG. 12 showing the utilization of a single data controller. A data controller 200 is connected to two sets of TFT arrays, in order to display images on the first side 202 and the second side 204 of the display. As shown in FIG. 13, the panel is divided into regions 206, 208. If the display is a two-side display, the first side 202 displays images in both the regions 206 and 208, and the second side 204 displays images in the region 208. The TFT arrays of the first side 202 are connected to all the nodes of the data controller 200, the TFT arrays of the second side 204 are connected to nodes a-i of the data controller 200. The data controller 200 obtains video data from the memory where video data are stored, to provide them to the TFT arrays of the first side 202 and the second side 204, in order to display the same image on both the first side 202 and the second side 204, or display a part of the image shown on the first side 202 by the second side 204. If the data controller 200 provides different video data to the TFT arrays of the first side 202 and the second side 204, they will not display the same image. A signal control unit 210 is connected to the gates of the TFT arrays of the first side 202 and the second side 204, in order to switch on and off the TFT arrays. Such kind of circuit structure can be formed on a TFT substrate or a flexible printed circuit (FPC) board. The signal control unit 210 controls the TFTs in regions A, B and C.

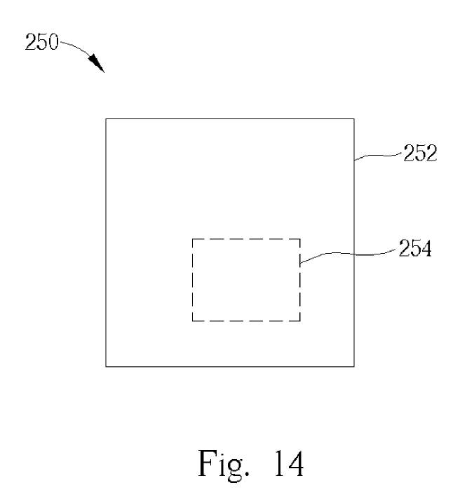

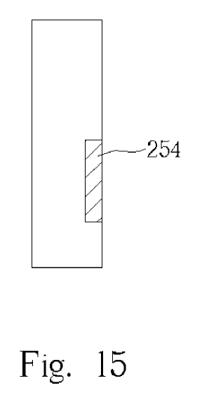

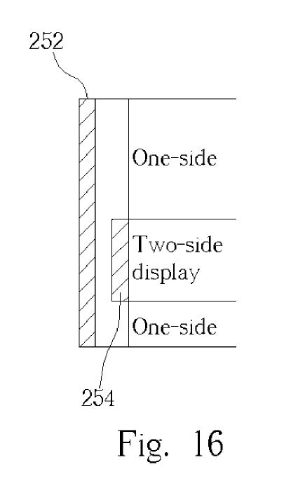

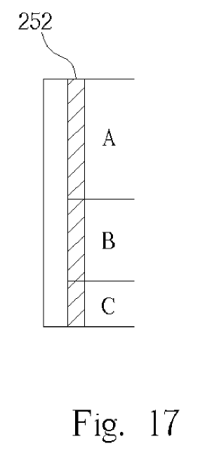

Please refer to FIG. 14 to FIG. 17 showing diagrams of a one-side or two-side display 250 according to the present invention. When displaying images on one side or two sides, the signal control unit switches on and off the driving arrays. Take an LCD as an example; the signal control unit is a gate IC for controlling the TFTs. As shown in FIG. 14, the first side 252 and the second side 254 are the two sides of the display 250. Please refer to FIGS. 15-17 showing side views of the display 250. As shown in FIG. 15, the display 250 displays images only on the second side 254. As shown in FIG. 16, the display 250 displays images both on the first side 252 and the second side 254. As shown in FIG. 17, the display 250 displays images on the first side 252. The first side 252 can be divided into several blocks, such as blocks A-C.

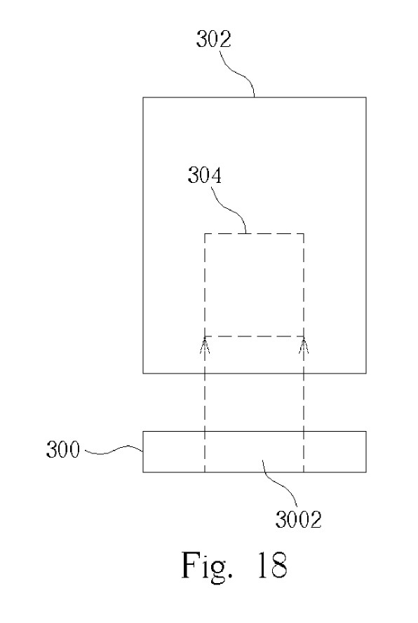

Please refer to FIG. 18 showing the first side and the second side of the display according to the present invention. The data controller 300 is a special IC having a region 3002. When displaying images on two sides, the data controller 300 provides the first side 302 and the second side 304 data to display the same image. The region 3002 provides the second side 304 and the block corresponding to the second side 304 on the first side 302 data to display images. When displaying images on one side, the data controller 300 provides multi-block display, and the region 3002 provides the block corresponding to the second side 304 on the first side 302 data to display. The first side 302 of the display is divided into two parts, a part corresponding to the second side 304 and the rest part, for displaying images.

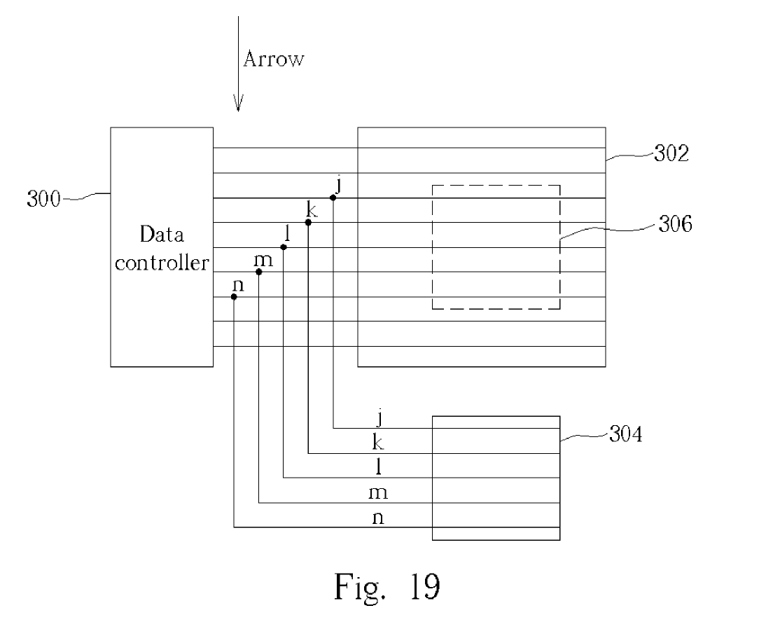

Please refer to FIG. 19 showing the first side and the second side displaying the same image. The data controller 300 is connected to the TFT arrays of the first side 302 and the second side 304. The first side 302 has a block 306 of the same size as the second side 304. The first side 302 is connected to all the nodes of the data controller 300, and the second side 304 is connected to nodes j-n of the data controller 300. The sequence of connection between the data controller 300 and the block 306 and the data controller 300 and the second side 304, is along the arrow shown in the FIG. 19. When displaying data on two sides, the block 306 and the second side 304 display the same image. If both the first side 302 and the second side 304 of the display are required to display the same image, all the nodes of the data controller 300 need connected to the second side 304.

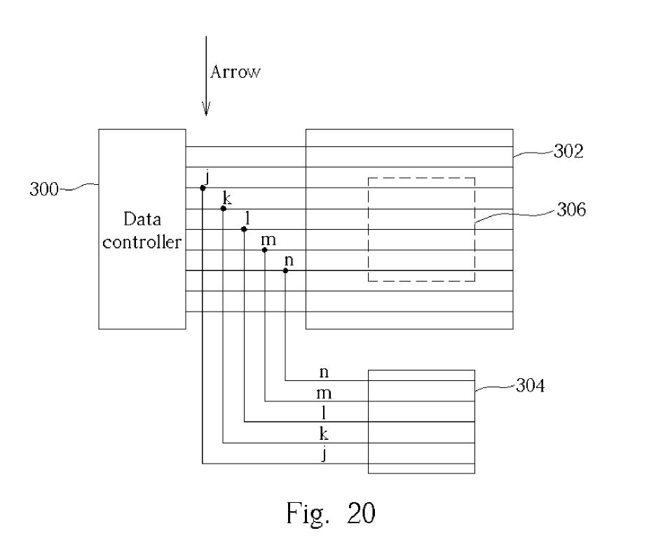

Please refer to FIG. 20 showing the first side and the second side displaying inverse images. The data controller 300 is connected to the TFT arrays of the first side 302 and the second side 304. The first side 302 has a block 306 of the same size as the second side 304. The first side 302 is connected to all the nodes of the data controller 300, and the second side 304 is connected to nodes j-n of the data controller 300. The sequence of connection between the data controller 300 and the block 306 is along the arrow shown in the figure, and the sequence of connection between the data controller 300 and the second side 304 is inverse to that. When displaying data on two sides, the block 306 and the second side 304 display inverse images. If both the first side 302 and the second side 304 of the display are required to display the same image, all the nodes of the data controller 300 need to be connected to the second side 304. As shown in FIG. 18 and FIG. 19, when using a single data controller and displaying images on two sides, the image displayed by the block 306 and the second side 304 is related to the sequence of connection as described above. If the block 306 and the second side 304 display the same image, the sequence of connection is the same, if not, the sequence of connection is inverse.

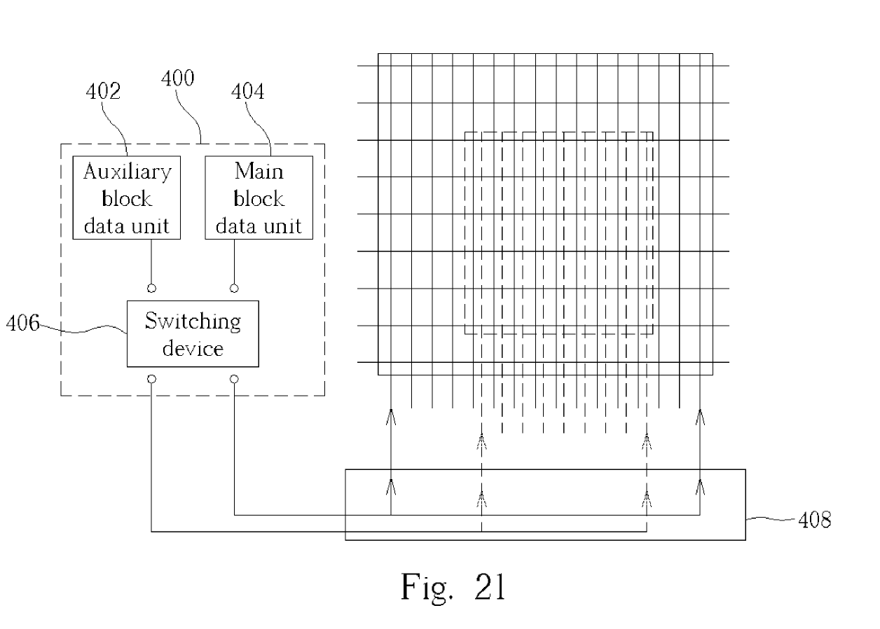

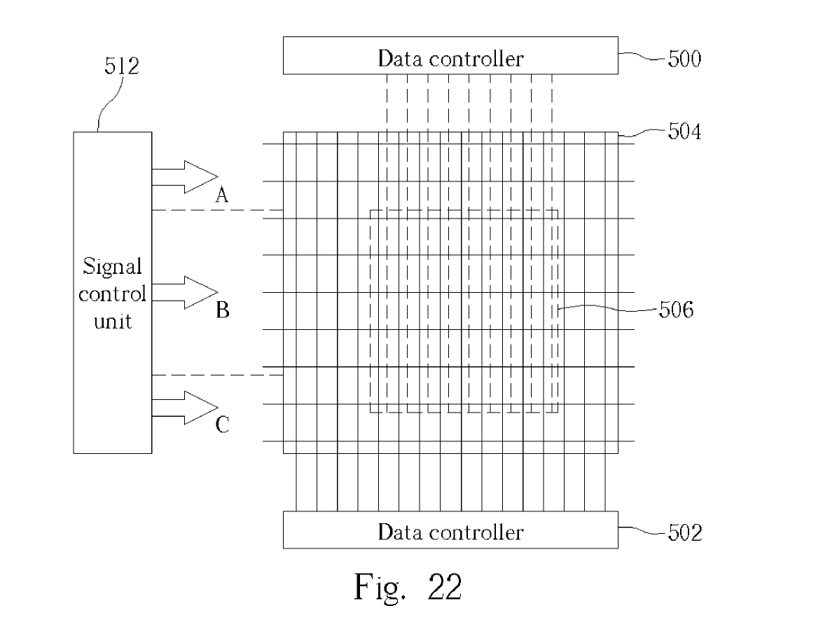

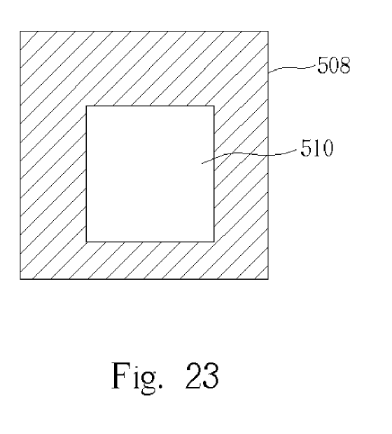

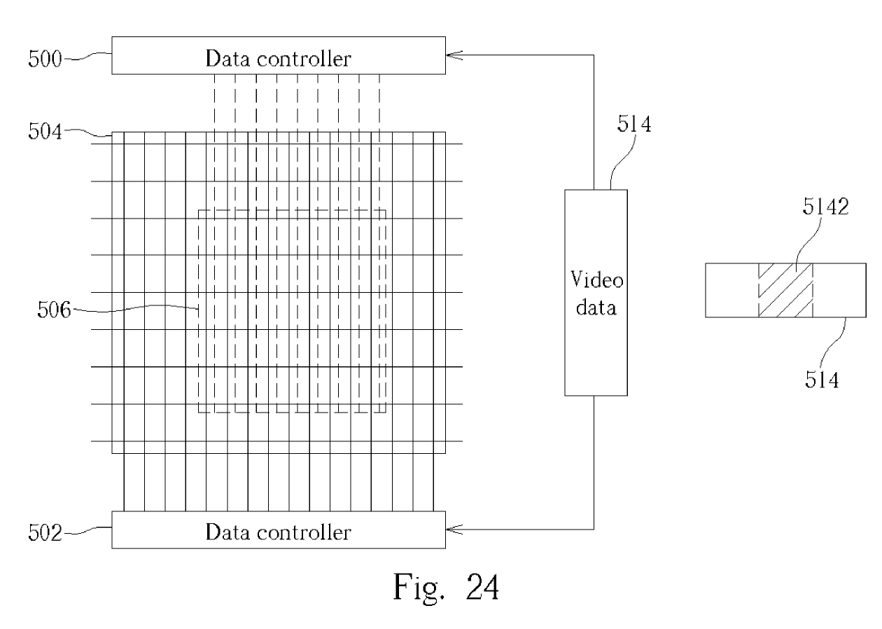

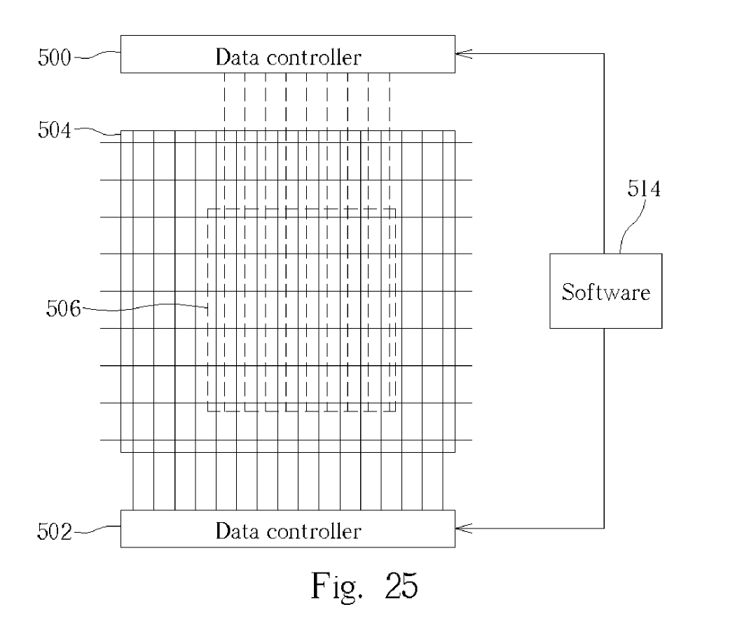

Please refer to FIG. 21 showing a circuit diagram of a two-side display according to the present invention. The data controller 408 is a special IC. The display has display switching device 400 including an auxiliary block data unit 402, a main block data unit 404, and a switching device 406. The display switching device 400 is connected to the data controller 408 and utilizes the switching device 406 to switch between the auxiliary block data unit 402 and the main block data unit 404. FIG. 22 shows a display using two data controllers according to the present invention. The data controllers 500, 502 are connected to two sets of TFT arrays, respectively. The data controller 500 provides the first side 506 data to display, and the data controller 502 provides the second side 504 data to display. As shown in FIG. 23, the panel is divided into two regions 508, 510. When displaying images on two sides, the first side 504 displays images in both the regions 508, 510, and the second side 506 displays images in the region 510. The data controllers 500, 502 obtain different video data from the memory, and then the data controller 500 provides the TFT arrays of the first side 504 data to display and the data controller 502 provides the TFT arrays of the second side 506 different data to display. The first side 504 and the second side 506 can display the same image or different images. The signal control unit 512 is connected to the gates of the TFT arrays of the first side 504 and the second side 506 to switch on and off the TFT arrays. This kind of circuit structure can be formed on a TFT substrate or a FPC board. The signal control unit 512 controls the switching of the TFT in regions A, B and C. FIG. 24 and FIG. 25 are circuit diagrams of the display using two data controllers. As shown in FIG. 24, the data controllers 500, 502 are connected to video data 514 having a movable region 5142 being a non-specific part of the video data 514. The video data 514 is provided by the data controller 500 to the first side 504, and the movable region 5142 is provided by the data controller 502 to the second side 506. According to the position of the movable region 5142, the second side 506 displays a different part of the image than displayed by the first side 504. The data controllers 500, 502 display different images if connected to different video data. As shown in FIG. 25, the data controller 500 transmits the video data displayed by the first side 504 to the data controller 502 under control of software 516, so that the video data displayed by the second side 506 is an enlargement or a reduction of the image displayed by the first side 504.

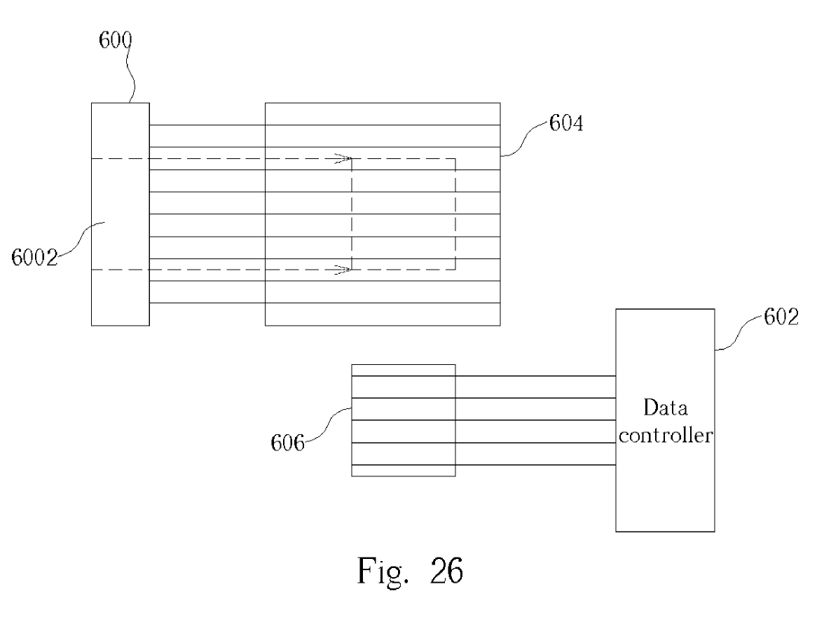

Please refer to FIG. 26 showing a two-side display using two data controllers according to the present invention. When displaying images on two sides, the data controllers 600, 602 respectively provide the first side 604 and the second side 606 data to display. The image displayed by the first side 604 and the second side 606 differs according to the video data provided by the data controllers 600, 602. When displaying images on one side, a multi-block display is provided by using one single data controller 602 or 604. For instance, the region 6002 of the data controller 600 provides the block corresponding to the second side 606 on the first side 604 data to display. The panel is divided into two regions, a part corresponding to the second side 606 and a remaining part. Subpixels of each pixel in the part corresponding to the second side 606 are of different structures.

In contrast to the prior art, the present invention provides a single display capable of displaying images on two sides. The panel according to the present invention is divided into at least two display regions, and pixels in the display regions are of different structures. The present invention controls the liquid crystal layer corresponding to subpixels of a pixel using different driving arrays in order to display a first and a second image on the first side, the second side, or on both sides.

Those skilled in the art will readily observe that numerous modifications and alterations of the device may be made while retaining the teachings of the invention. Accordingly, the above disclosure should be construed as limited only by the metes and bounds of the appended claims

1. A display having a plurality of display regions, the display comprising at least:
a first display region and a second display region having different display modes;
a first pixel array and a second pixel array; and
a first driving array and a second driving array,
wherein the driving arrays are used to control the image display of the display regions of the display.

2. The display of claim 1, further comprising:
a liquid crystal layer located between a first substrate and a second substrate,
wherein the first display region and the second display region of the liquid crystal layer have different display modes.

3. The display of claim 1, being an organic light emitting display, a cold light display, or an electrophoretic display.

4. The display of claim 1, being a flat panel display.

5. The display of claim 1, wherein each display region has its pixel array.

6. The display of claim 1, wherein the color of each display region is different.

7. The display of claim 5, wherein the pixel array of each display region has the same structure.

8. The display of claim 5, wherein the pixel array of each display region has different structure.

9. The display of claim 5, wherein the pixel array of each display region has different shape.

10. The display of claim 5, wherein the pixel of each display region comprises at least one other pixel.

11. The display of claim 5, wherein the pixel array of each display region has different transmission rate or reflective rate.

12. The display of claim 5, wherein the color of the pixel array of each display region is different.

13. The display of claim 5, wherein the pixel array of each display region comprises at least one subpixel array.

14. The display of claim 13, wherein the pixel array of each display region comprises at least two sets of subpixel arrays.

15. The display of claim 13, wherein the pixel of each display region comprises at least one other subpixel.

16. The display of claim 13, wherein the subpixel of each display region comprises at least one other subpixel.

17. The display of claim 13, wherein the subpixels are periodically arranged in the pixel arrays.

18. The display of claim 13, wherein the transmission rate or the reflective rate of the subpixels in the pixel arrays is different.

19. The display of claim 13, wherein the subpixels in the pixel arrays have different structures.

20. The display of claim 13, wherein the color of each subpixel in the pixel arrays is different.

21. The display of claim 1, further comprising a signal control unit for controlling each driving array to be switched on and off.

22. The display of claim 1, further comprising a data controller having nodes connected to each driving array.

23. The display of claim 22, wherein the nodes are arranged in order.

24. The display of claim 22, wherein a first image comprises a block being the same as a second image or inverse to the second image, defined by the sequence of connection of the nodes.

25. The display of claim 22, further comprising a first and second image display switching device connected to the data controller.

26. The display of claim 25, wherein the data controller comprises:
a first image data unit and a second image data unit; and
a switching device connected to the first image data unit and the second image data unit, in order to switch between the first image and the second image.

27. The display of claim 1, further comprising a first data controller connected to the first driving array, and a second data controller connected to the second driving array.

28. The display of claim 1, wherein the first image and the second image are displayed simultaneously.

29. The display of claim 1, wherein the first image and the second image are the same.

30. The display of claim 1, wherein the second image is the inverse of the first image.

31. The display of claim 1, wherein the second image is a part of the first image.

32. The display of claim 1, wherein the second image is a part of the inverse of the first image.

33. The display of claim 1, wherein the second image is a reduction of the first image.

34. The display of claim 1, wherein the second image is a reduction of the inverse of the first image.

35. The display of claim 1, wherein the first driving array and the second driving array are thin film transistors (TFT).

36. The display of claim 1, wherein the second driving array is a part of the first driving array.
